(19) United States
(12) Patent Application Publication
(10) Pub. No.: US 2011/0049981 A1
(43) Pub. Date: Mar. 3, 2011

(54) Electric Shock Proof Socket Circuit

(76) Inventors: Jui-Hsiung Wu, Taipei (TW); Kuo-Nan Wu, Taipei (TW)

(21) Appl. No.: 12/553,092

(22) Filed: Sep. 2, 2009

(51) Int. Cl. H02J 3/00

(52) U.S. Cl. 307/26

(57) ABSTRACT

An electric shock proof socket circuit includes a power supply module for stepping down and rectifying an input voltage and then providing the step-down and rectified voltage to a detecting module and a switching module. The detecting module includes a light-emitting unit and a light-receiving unit. The light-emitting unit is used for emitting light for the light-receiving unit. Whether the light from the light-emitting unit is received by the light-receiving unit or not makes the detecting module send corresponding control signals. The switching module controls power output of the socket circuit according to the control signals for preventing an electric shock danger. So the electric shock proof socket circuit has the advantages of security and convenience.

### BACKGROUND OF THE INVENTION

1. Field of the Invention

The present invention generally relates to a socket circuit, and more particularly to an electric shock proof socket circuit.

2. The Related Art

In a conventional socket, the conductive pieces are adjacent to the inserting holes. When the pins or the prongs of a plug are inserted into the corresponding inserting holes of the socket, they contact the conductive pieces to form an electrical connection therebetween. However, no stoppers are provided between the conductive pieces and the pins, so that a dangerous condition may occur. If a child inserts an undesired object into the inserting hole, the child may possibly get an electric shock. So an improved socket is provided with an electric shock proof protector. The protector is achieved with a helical-type compressible spring. However, because the space in the socket is small, it is difficult to insert the spring in the socket. In addition, the spring often has a problem of elastic fatigue, thereby reduces the effectiveness of the protector.

### SUMMARY OF THE INVENTION

An object of the present invention is to provide an electric shock proof socket circuit including a power supply module, a detecting module and a switching module. The power supply module is adapted for stepping down and rectifying an external input voltage and then providing the step-down and rectified voltage to the detecting module and the switching module. The detecting module includes a light-emitting unit and a light-receiving unit. The light-emitting unit is used for emitting light to the light-receiving unit. Whether the light emitted from the light-emitting unit being received by the light-receiving unit or not makes the detecting module send corresponding control signals. The switching module controls the power output of the socket circuit according to the control signals sent from the detecting module.

As described above, the electric shock proof socket circuit of the present invention utilizes the detecting module to emit-receive the light so as to drive the switching module to control the power output of the socket for preventing an electric shock danger. So the electric shock proof socket circuit of the present invention has the advantages of security and convenience.

### BRIEF DESCRIPTION OF THE DRAWINGS

The present invention will be apparent to those skilled in the art by reading the following description, with reference to the attached drawings, in which:

FIG. 1 is a circuitry of an electric shock proof socket circuit according to the present invention.

### DETAILED DESCRIPTION OF THE PREFERRED EMBODIMENT

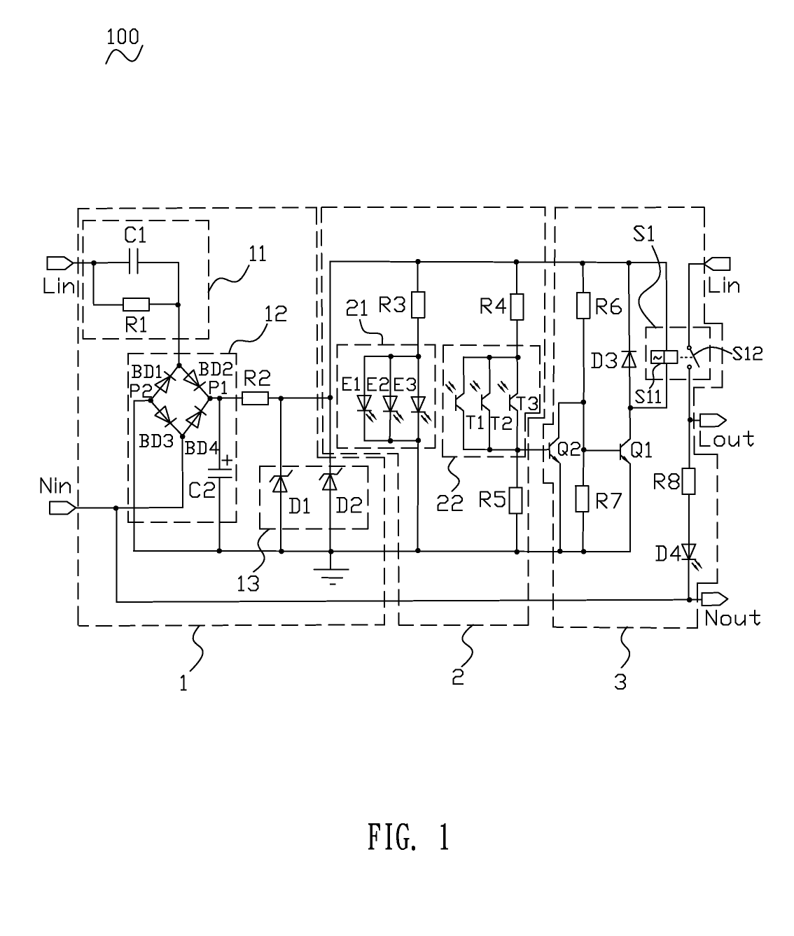

With reference to FIG. 1, an electric shock proof socket circuit 100 of the present invention includes a power supply module 1, a detecting module 2 and a switching module 3. The power supply module 1 includes a step-down circuit 11, a rectifying and filtering circuit 12 and a voltage-regulating circuit 13. The step-down circuit 11 is connected with a live wire input Lin for getting an input voltage therefrom and further has a step-down function to the input voltage. The step-down circuit 11 includes a step-down capacitor C1 and a first resistor R1 parallel-connected with the step-down capacitor C1.

The rectifying and filtering circuit 12 includes a rectifier connected with the step-down circuit 11 for rectifying the step-down voltage from the step-down circuit 11, and a filter connected with the rectifier for filtering the rectified voltage by the rectifier. In this embodiment, the rectifier is a bridge rectifier composed of a first rectifying diode BD1, a second rectifying diode BD2, a third rectifying diode BD3 and a fourth rectifying diode BD4, and the filter is a filtering capacitor C2. The cathode of the first rectifying diode BD1 and the anode of the second rectifying diode BD2 are connected with each other and further connected with the step-down circuit 11. The cathode of the third rectifying diode BD3 and the anode of the fourth rectifying diode BD4 are connected with each other and further connected with a neutral wire input Nin. The cathodes of the second and fourth rectifying diodes BD2, BD4 are connected with each other and the connection point thereof is defined as a first connecting terminal P1. The anodes of the first and third rectifying diodes BD1, BD3 are connected with each other and the connected point thereof is defined as a second connecting terminal P2 connected to ground. The positive electrode of the filtering capacitor C2 is connected with the first connecting terminal P1, and the negative electrode thereof is connected with the second connecting terminal P2.

The voltage-regulating circuit 13 includes two voltage-regulating diodes D1, D2 parallel-connected with each other with the cathodes connected to the first connecting terminal P1 through a second resistor R2 and the anodes connected with the second connecting terminal P2 so as to regulate the rectified and filtered voltage by the rectifying and filtering circuit 12 for the detecting module 2 and the switching module 3.

The detecting module 2 includes a light-emitting unit 21 including three parallel-connected light-emitting elements E1˜E3, and a light-receiving unit 22 including three parallel-connected photosensitive elements T1˜T3. One terminal of the light-emitting unit 21 is connected to the first connecting terminal P1 through a third resistor R3 and the second resistor R2, and the other terminal thereof is connected with the second connecting terminal P2 of the rectifying and filtering circuit 12. One terminal of the light-receiving unit 22 is connected to the first connecting terminal P1 through a fourth resistor R4 and the second resistor R2, and the other terminal thereof is connected to the second connecting terminal P2 through a fifth resistor R5. The three photosensitive elements T1˜T3 are located to one-to-one face the corresponding light-emitting elements E1˜E3, and both each of the photosensitive elements T1˜T3 and the corresponding one of the light-emitting elements E1˜E3 are located at two opposite sides of a corresponding inserting hole of a socket (not shown) with the electric shock proof socket circuit 100 therein. In the embodiment, the light-emitting elements E1˜E3 are respectively an infrared emitter and the photosensitive elements T1˜T3 are respectively a photosensitive triode, wherein the connection and the disconnection of the photosensitive triode are controlled according to whether the light from the corresponding infrared emitter can be received or not.

The switching module 3 includes a first switch Q1, a second switch Q2 and an inductance switch S1. In the embodiment, the first switch Q1 and the second switch Q2 are respectively a transistor. The collector of the second switch Q2 is on one hand connected to the first connecting terminal P1 of the bridge rectifier through a sixth resistor R6 and the second resistor R2, and on the other hand, connected to the emitter thereof through a seventh resistor R7. The base of the second switch Q2 is connected at the connection location of the light-receiving unit 22 and the fifth resistor R5, and the emitter thereof is further directly connected with the second connecting terminal P2 of the bridge rectifier. The base of the first switch Q1 is connected with the collector of the second switch Q2, the emitter thereof is connected with the second connecting terminal P2 of the bridge rectifier, and the collector thereof is connected to the second resistor R2 through a directive diode D3, wherein the directive diode D3 can guide a backflow current produced by the disconnection of the first switch Q1 so as to protect the first switch Q1.

In the embodiment, the inductance switch S1 is an electromagnetic relay composed of a control system S11 and a switch system S12, wherein the switch state of the switch system S12 is controlled according to whether there is a voltage on the control system S11 or not. The control system S11 is parallel-connected to the directive diode D3. One terminal of the switch system S12 is connected with the live wire input Lin, and the other terminal thereof is connected to the neutral wire input Nin successively through an eighth resistor R8 and an indicating element, wherein the indicating element is used to indicate the switch state of the switch system S12. In the embodiment, the indicating element is a light-emitting diode D4, when the inductance switch S1 is connected, the light-emitting diode D4 is lighted. The connection location of the switch system S12 and the eighth resistor R8 is drawn forth as a live wire output Lout, and the neutral wire input Nin is also acted as a neutral wire output Nout. When pins or prongs of an external plug are respectively inserted into the inserting holes of the socket, the pins or prongs are electrically connected with the corresponding live wire output Lout and the neutral wire output Nout.

When the socket is not in use, namely all of the inserting holes of the socket are not inserted with the pins of the plug or undesired objects, the light emitted by the light-emitting elements E1˜E3 is respectively received by the corresponding photosensitive elements T1˜T3 so that makes the light-receiving unit 22 connected. So a high-voltage signal is transmitted to the base of the second switch Q2 to make the second switch Q2 connected and accordingly the first switch Q1 disconnected. As a result, the inductance switch S1 is in a disconnected state due to the status of no voltage thereon. So there is no power to be output by the live wire output Lout.

When the number of the pins of the plug is less than three, or there are less than three undesired objects inserted into the inserting holes of the socket, namely if only there is one of the inserting holes without being inserted with the pin of the plug or the undesired object, the light emitted by the exposed one of the light-emitting elements E1˜E3 can be received by the corresponding exposed photosensitive element T1/T2/T3 so as to make the light-receiving unit 22 connected that can make a high-voltage signal transmitted to the base of the second switch Q2 to make the second switch Q2 connected and accordingly the first switch Q1 disconnected. So the inductance switch S1 is in the disconnected state due to the status of no voltage thereon, and there is still no power to be output by the live wire output Lout.

When the pins of the plug are wrongly inserted into the inserting holes of the socket, or each of the inserting holes of the socket is inserted with the undesired object, but if only there is the light from any of the light-emitting elements E1˜E3 unobstructed completely by the pin or the undesired object, the corresponding photosensitive element T1/T2/T3 can receive the unobstructed light to make the light-receiving unit 22 connected and further make the second switch Q2 connected and accordingly the first switch Q1 disconnected. So the inductance switch S1 is still in the disconnected state due to the status of no voltage thereon, and there is still no power to be output by the live wire output Lout.

When each of the inserting holes of the socket is rightly inserted with the corresponding pin of the plug, the light emitted by the light-emitting elements E1˜E3 is completely obstructed by the corresponding pins of the plug so that makes the light-receiving unit 22 disconnected. So a low-voltage signal is transmitted to the base of the second switch Q2 to make the second switch Q2 disconnected so that there is a current flew through the seventh resistor R7 and the first switch Q1 is connected to produce voltage on the control system S11 of the inductance switch S1. Therefore, the switch system S12 of the inductance switch S1 is connected to make the live wire output Lout output power for the plug.

As described above, the electric shock proof socket circuit 100 of the present invention utilizes the detecting module 2 to emit-receive the light so as to drive the switching module 3 to control the power output of the socket for preventing an electric shock danger. So the electric shock proof socket circuit 100 of the present invention has the advantages of security and convenience.

What is claimed is:

1. An electric shock proof socket circuit, comprising:
a power supply module for stepping down and rectifying an external input voltage and then providing the step-down and rectified voltage to a detecting module and a switching module;
the detecting module including a light-emitting unit and a light-receiving unit, the light-emitting unit emitting light for the light-receiving unit, whether the light from the light-emitting unit is received by the light-receiving unit or not making the detecting module send corresponding control signals; and
the switching module controlling power output of the socket circuit according to the control signals sent from the detecting module.

2. The electric shock proof socket circuit as claimed in claim 1, wherein the power supply module includes a step-down circuit for stepping down the input voltage, a rectifying and filtering circuit for rectifying the step-down voltage and then filtering the rectified voltage, and a voltage-regulating circuit for regulating the filtered voltage.

3. The electric shock proof socket circuit as claimed in claim 1, wherein the light-emitting unit includes a plurality of parallel-connected light-emitting elements and the light-receiving unit includes a plurality of parallel-connected photosensitive elements each located to correspond to the respective light-emitting element.

4. The electric shock proof socket circuit as claimed in claim 3, wherein the light-emitting element is an infrared emitter and the photosensitive element is a photosensitive triode.

5. The electric shock proof socket circuit as claimed in claim 1, wherein the switching module includes a second switch controlled by the control signals sent from the detecting module, a first switch controlled by the second switch, and an inductance switch, whether there is voltage on the inductance switch or not is controlled by the first switch, the inductance switch is disconnected when there is no voltage thereon and no power is output by the socket circuit, the inductance switch is connected when there is voltage thereon and the socket circuit provides power.

6. The electric shock proof socket circuit as claimed in claim 5, wherein the inductance switch is an electromagnetic relay.

7. The electric shock proof socket circuit as claimed in claim 5, wherein the switching module further includes an indicating element capable of being lighted when the inductance switch is connected.

8. The electric shock proof socket circuit as claimed in claim 7, wherein the indicating element is a light-emitting diode.
